(19) United States
(12) Patent Application Publication
(10) Pub. No.: US 2025/0146953 A1
(43) Pub. Date: May 8, 2025

(54) SYSTEM AND METHOD FOR INSPECTING OPTICAL FIBERS

(71) Applicant: CORNING RESEARCH & DEVELOPMENT CORPORATION, Corning, NY (US)

(72) Inventors: Sang-Mook Lee, Horseheads, NY (US); Zhaoxu Tian, Hickory, NC (US); Cameron John Tovey, Conover, NC (US)

(21) Appl. No.: 18/375,052

(22) Filed: Sep. 29, 2023

(51) Int. Cl. G01N 21/952; G01N 21/88

(52) U.S. Cl. CPC G01N 21/952; G01N 21/8806

(57) ABSTRACT

A system for connectorizing optical fibers receives an image of an optical fiber and segments the image along an image dimension corresponding to a length of the optical fiber to generate a plurality of image lines. Each image line includes a plurality of foreground pixels associated with the optical fiber and a plurality of background pixels associated with a background of the image. For each image line, the system defines a background intensity based on one or more background pixels and a foreground intensity based on one or more foreground pixels. The system compares the foreground intensity to the background intensity to identify any defects and logs each defect identified. If the number of defects logged is below a predetermined defect threshold, the optical fiber is ready to receive a connector. Otherwise, the optical fiber is not ready to receive the connector.

### TECHNICAL FIELD

This disclosure relates generally to inspection of optical fibers, and more particularly to a systems, methods, and computer program products for inspecting optical fibers after coating removal to determine if they are ready to accept a connector.

### BACKGROUND

Optical fibers are useful in a wide variety of applications, including the telecommunications industry for voice, video, and data transmissions. Benefits of optical fibers include wide bandwidth and low noise operation. FIGS. 1 and 2 depict side and end cross-sectional views (respectively) of an exemplary fiber optic cable 10. The fiber optic cable 10 includes an optical fiber 12 and a protective buffer 14 that surrounds and protects the optical fiber 12. The fiber optic cable 10 may also include abrasion resistant outer jacket (not shown) that surrounds the protective buffer 14. The buffer 14 and outer jacket provide protective coatings that prevent the optical fiber 12 from being damaged by normal handling, such as when the fiber optic cable 10 is pulled through a conduit during installation in a fiber optic network. The optical fiber 12 includes a core 16 and a cladding 18 that surrounds the core 16. The core 16 and cladding 18 are typically made of fused silica doped to have different indexes of refraction. The core 16 and cladding 18 of optical fiber 12 work cooperatively to define an optical waveguide that generally confines optical signals propagating through the fiber optic cable 10 to a region of the optical fiber 12 within and immediately adjacent to the core 16.

In a fiber optic network, there are typically many locations where fiber optic cables 10 containing one or more optical fibers 12 connect to equipment or other fiber optic cables 10. To conveniently provide these connections, fiber optic connectors are often provided on the ends of fiber optic cables 10. Connectors enable fiber optical cables to be non-permanently connected and disconnected to other optical elements in the fiber optic network. As part of the connectorizing process, the protective coatings are typically removed from the optical fiber 12 prior to inserting the optical fiber 12 into a ferrule of the connector. However, if the protective coatings are not properly removed, remaining portions of the coatings can prevent the optical fiber 12 from being properly mated with the ferrule. Poor mating between the optical fiber 12 and ferrule may result in misalignments and/or poor adhesion between the optical fiber 12 and ferrule, which can result in signal losses in the fiber optic network.

Thus, there is a need in the fiber optic industry for improved systems, methods, and computer program products for quantifying optical fiber cleanliness that enables a suitable threshold to be consistently applied to the optical fiber 12 as part of the connectorization process.

### SUMMARY

In an aspect, an improved system for connectorizing an optical fiber is disclosed. The system includes one or more processors, and a memory including program code. When executed by the one or more processors, the program causes the system to receive an image of the optical fiber, and segment the image along an image dimension corresponding to a length of the optical fiber to generate a plurality of image lines. Each image line includes a plurality of foreground pixels associated with the optical fiber and a plurality of background pixels associated with a background of the image. For each image line, the program code further causes the system to define a background intensity based on one or more background pixels of the plurality of background pixels, define a foreground intensity based on one or more foreground pixels of the plurality of foreground pixels, compare the foreground intensity to the background intensity to identify any defects, and log each defect identified. The program code causes the system to pass the optical fiber if a number of defects logged is below a predetermined defect threshold, and not pass the optical fiber if the number of defects is not below the predetermined defect threshold.

In an embodiment of the disclosed system, the foreground intensity may be an average of an intensity of each foreground pixel, the background intensity may be an average of the intensity of each background pixel, and the program code may cause the system to compare the foreground intensity to the background intensity by determining a light transmission ratio as a ratio of the foreground intensity of the image line and the background intensity of the image line, comparing the light transmission ratio to a predetermined light transmission threshold, and identifying a defect if the light transmission ratio differs from the predetermined light transmission threshold by more than a predetermined amount.

In another embodiment of the disclosed system, the program code may cause the system to compare the foreground intensity to the background intensity by, for each foreground pixel, defining a threshold intensity as a percentage of the background intensity, comparing the intensity of the foreground pixel to the threshold intensity, identifying the defect if the intensity of the foreground pixel is less than the threshold intensity, and not identifying the defect if the intensity of the foreground pixel is not less than the threshold intensity.

In another embodiment of the disclosed system, the image received may be one of a plurality of images of the optical fiber, and the number of defects logged may represent a sum of the number of defects identified in each image of the plurality of images.

In another embodiment of the disclosed system, the system may further include an imager in communication with the one or more processors, and the program code may further cause the system to capture at least one image of the optical fiber from each of a plurality of angular positions to generate the plurality of images of the optical fiber.

In another embodiment of the disclosed system, the system may further include one or more rotary stages configured to rotate the optical fiber relative to the imager, and the program code may cause the system to capture the image of the optical fiber from each of the plurality of angular positions by rotating the optical fiber relative to the imager, and activating the imager each time the optical fiber is at one of the plurality of angular positions.

In another embodiment of the disclosed system, the program code may cause the system to rotate the optical fiber in predetermined angular steps to each of the plurality of angular positions.

In another embodiment of the disclosed system, the imager may include an image sensor and an optical assembly, and the optical assembly may be configured to receive light from the optical fiber, optically divide the light into a plurality of portions, and map each portion of the light to a different region of the image sensor.

In another embodiment of the disclosed system, the system may further include a linear stage in communication with the one or more processors and be configured to operatively couple the imager to the optical fiber, and the program code may further cause the system to activate the linear stage to move the imager relative the optical fiber so that the imager is scanned along the length of the optical fiber, capture a plurality of image lines as the imager is scanned along the length of the optical fiber, and define the image from the image lines.

In another aspect, an improved method for connectorizing the optical fiber is disclosed. The method includes receiving the image of the optical fiber and segmenting the image along the image dimension corresponding to the length of the optical fiber to generate the plurality of image lines. Each image line includes the plurality of foreground pixels associated with the optical fiber and the plurality of background pixels associated with the background of the image. For each image line, the method defines a background intensity based on one or more background pixels of the plurality of background pixels and a foreground intensity based on one or more foreground pixels of the plurality of foreground pixels, compares the foreground intensity to the background intensity to identify any defects, and logs each defect identified. The method passes the optical fiber if the number of defects logged is below the predetermined defect threshold, and does not pass the optical fiber if the number of defects is not below the predetermined defect threshold.

In an embodiment of the disclosed method, the foreground intensity may be the average of the intensity of each foreground pixel, the background intensity may be the average of the intensity of each background pixel, and comparing the foreground intensity to the background intensity may include determining the light transmission ratio as the ratio of the foreground intensity of the image line and the background intensity of the image line, comparing the light transmission ratio to the predetermined light transmission threshold, and identifying the defect if the light transmission ratio differs from the predetermined light transmission threshold by more than the predetermined amount.

In another embodiment of the disclosed method, comparing the foreground intensity to the background intensity may include, for each foreground pixel, defining the threshold intensity as the percentage of the background intensity, comparing the intensity of the foreground pixel to the threshold intensity, identifying the defect if the intensity of the foreground pixel is less than the threshold intensity, and not identifying the defect if the intensity of the foreground pixel is not less than the threshold intensity.

In another embodiment of the disclosed method, the image received may be one of the plurality of images of the optical fiber, and the number of defects logged may represent the sum of the number of defects identified in each image of the plurality of images.

In another embodiment of the disclosed method, the method may further include capturing at least one image of the optical fiber from each of the plurality of angular positions to generate the plurality of images of the optical fiber.

In another embodiment of the disclosed method, capturing the image of the optical fiber from each of the plurality of angular positions may include rotating the optical fiber relative to the imager, and activating the imager each time the optical fiber is at one of the plurality of angular positions.

In another embodiment of the disclosed method, the optical fiber may be rotated in predetermined angular steps to each of the plurality of angular positions.

In another embodiment of the disclosed method, capturing the image may include receiving light from the optical fiber, optically dividing the light into a plurality of portions, and optically folding the image by mapping each portion of the light to a different region of the image sensor.

In another embodiment of the disclosed method, capturing the image may include moving one of the imager or the optical fiber so that the imager is scanned along the length of the optical fiber, capturing the plurality of image lines as the imager is scanned along the length of the optical fiber, and defining the image from the image lines.

In another embodiment of the disclosed method, the imager may be a line imager.

In another aspect, a computer program product for connectorizing the optical fiber is disclosed. The computer program product includes a non-transitory computer-readable storage medium, and program code stored on the non-transitory computer-readable storage medium. When executed by one or more processors, the program code causes the one or more processors to receive the image of the optical fiber, and segment the image along the image dimension corresponding to the length of the optical fiber to generate the plurality of image lines. Each image line includes the plurality of foreground pixels associated with the optical fiber and the plurality of background pixels associated with the background of the image. For each image line, the program code causes the one or more processors to define the background intensity based on one or more background pixels of the plurality of background pixels, define the foreground intensity based on one or more foreground pixels of the plurality of foreground pixels, compare the foreground intensity to the background intensity to identify any defects, and log each defect identified. The program code causes the one or more processors to pass the optical fiber if the number of defects logged is below the predetermined defect threshold, and reject the optical fiber if the number of defects is not below the predetermined defect threshold.

### BRIEF DESCRIPTION OF THE DRAWINGS

The accompanying drawings are included to provide a further understanding and are incorporated in and constitute a part of this specification.

The drawings illustrate one or more embodiments, and together with the description serve to explain principles and operation of the various embodiments. Features and attributes associated with any of the embodiments shown or described may be applied to other embodiments shown, described, or appreciated based on this disclosure.

FIG. 1 is a lengthwise cross-sectional view of an optical fiber.

FIG. 2 is an endwise cross-sectional view of the optical fiber of FIG. 1.

FIG. 3 is schematic view of an exemplary fiber inspection system including an imager.

FIG. 4 is a schematic view of an embodiment of the imager of FIG. 3.

FIGS. 5 and 6 are exemplary images of an optical fiber that may be generated by the imager of FIG. 3.

FIG. 7 is a diagrammatic view depicting exemplary fields of view for various embodiments of the imager of FIG. 3.

FIG. 8 is a diagrammatic view depicting exemplary imaging regions for images generated by the imager of FIG. 3.

FIG. 9 is a diagrammatic view depicting exemplary positions of the imager of FIG. 3 relative to a fiber optic cable including a plurality of optical fibers.

FIG. 10 is a flowchart depicting a process that may be executed by the system of FIG. 3.

FIG. 11 is a schematic view of a computer that may be used to implement one or more of the components or processes depicted by FIGS. 3-10.

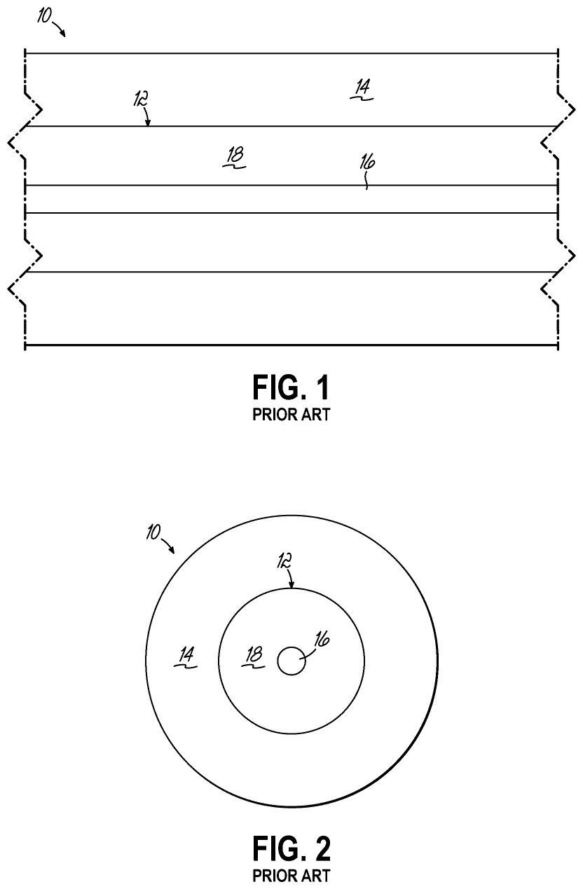

### DETAILED DESCRIPTION

Various embodiments will be further clarified by examples in the description below. In general, the description relates to a system, method, and computer program product for inspecting optical fibers 12 for cleanliness and other defects. The system, method, or computer program product automatically captures and analyzes images of the optical fiber 12 to provide a 360 degree view thereof. The status of the optical fiber 12 is then defined by one or more quantitative values determined from the image analysis. These quantitative values may be compared to one or more threshold values to determine if the optical fiber 12 is ready to be connectorized, or whether remedial action (e.g., cleaning or further stripping) of the optical fiber 12 is needed prior to connectorizing.

Disclosed embodiments provide technical and competitive advantages through improved quality assurance and fiber optic cable throughput. Advantages include objective characterization of fiber cleanliness, the ability to inspect both single fiber and multifiber ribbon cables, providing consistent and reliable evaluations of optical fibers 12, the ability to provide three-dimensional images of the optical fiber 12, and increased automation of connectorizing processes.

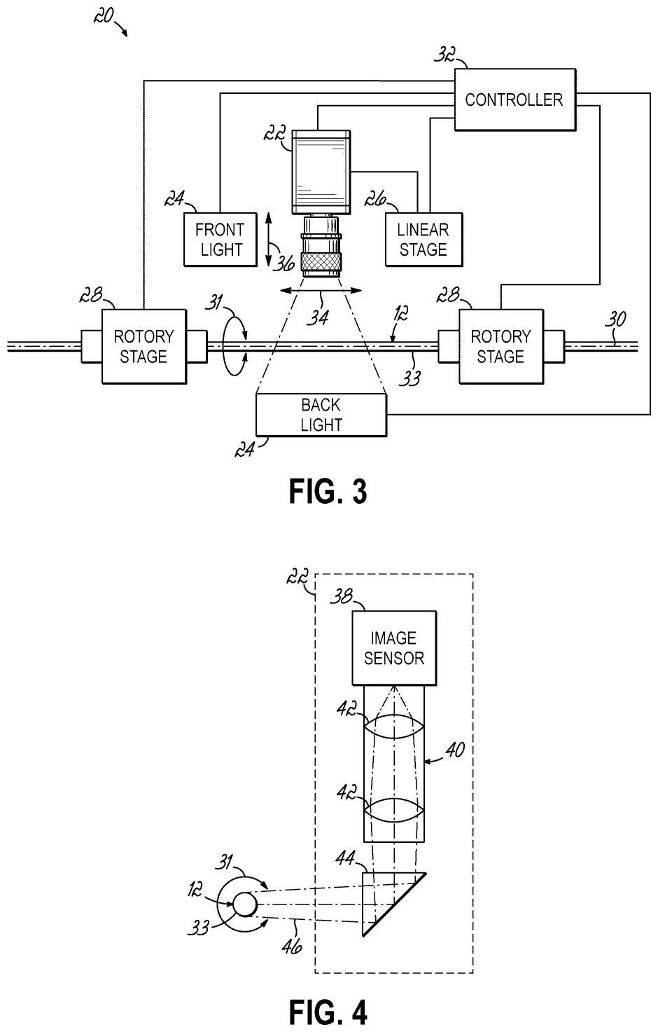

FIG. 3 depicts a fiber inspection system 20 including an imager 22, one or more light sources 24 (e.g., a front light source and a back light source) a linear stage 26 configured to position the imager 22 relative to an optical fiber 12 under test, one or more rotary stages 28 configured to rotate the optical fiber 12 about an axis of rotation 30 (as indicated by double arrowed line 31), and a controller 32 that is operatively coupled to one or more of the imager 22, light sources 24, and stages 26, 28.

The imager 22 may be placed in relation to the rotary stages 28 so that an optical axis of the imager 22 is generally perpendicular to, and aligned with, the optical fiber 12. A front light source 24 (e.g., a coaxial light mounted proximate to the imager 22) may be used for collecting data relating to the outer surface 33 of optical fiber 12. A back light source 24 (e.g., a light panel mounted behind the optical fiber 12 opposite of the imager 22) may be used to capture images suitable for tomographic reconstruction of the optical fiber 12. Back light sources 24 may be placed so that they are also aligned with and perpendicular the optical axis of the imager 22. Additional light sources (not shown) may be configured to illuminate the optical fiber 12 from the front or sides.

The linear stage 26 may be configured to, in response to being activated by the controller 32, selectively move the imager 22 along the length of the optical fiber 12 (i.e., in an “x-direction” as indicated by double arrowed line 34), towards or away from the optical fiber 12 (i.e., in a “z-direction” as indicated by double arrowed line 36), and/or in a direction tangential to the optical fiber 12 (i.e., in a “y-direction” orthogonal to both the x and z-directions). The linear stage 26 may include, for example, one or more (e.g., one for each direction of movement) linear stroke stages, such as a 25 mm stroke linear stage with 1 μm resolution manufactured by Parker Hannifin of Cleveland, Ohio, United States.

The rotary stages 28 may include, for example, direct drive analog rotary stages available from Akribis Systems of Beverly, Massachusetts, United States. For embodiments of the fiber inspection system 20 having two rotary stages 28, rotation of the rotary stages 28 may be synchronized to avoid twisting the optical fiber 12. The rotary stages 28 may also be configured to provide sufficient tension on the optical fiber 12 to keep the optical fiber 12 in a generally straight line. The fiber inspection system 20 may thereby be configured to image the optical fiber 12 from any angle. Multiple images captured from different angles may be used for complete inspection of the optical fiber 12.

For example, the fiber inspection system 20 may rotate the optical fiber 12 in 30-degree steps, capturing an image at each step, so that twelve images are captured per optical fiber 12. Other examples of angular steps that may be used to cover the entire outer surface 33 of the optical fiber 12 include two images spaced 180 degrees apart, three images spaced 120 degrees apart, and four images spaced 90 degrees apart. However, it should be understood that embodiments of the fiber inspection system 20 are not limited to a specific number and/or spacing of rotation angles at which images are captured.

Additional exemplary components that may be used in the fiber inspection system 20 (e.g., to operatively couple the controller 32 to one or more of the stages 26, 28) may include, but are not limited to, a 16-axis EtherCAT motion controller, a 4-axis 80 volt DC smart amplifier, a torque off cable and connector kit for the amplifier, and a sin-cos to quadrature converter, all of which may be obtained from ACS Motion Control of Edina, Minnesota, United States. Additional exemplary components may include 24 volt 120 watt and 48 volt 240 watt power supplies, both available from Omron of Hoffman Estates, Illinois, United States.

FIG. 4 depicts an exemplary embodiment of the imager 22 of fiber inspection system 20. The exemplary imager 22 includes an image sensor 38 (e.g., a charge-coupled device (CCD) or active-pixel (CMOS) sensor), a lens assembly 40 comprising one or more lenses 42, and an optical assembly 44. The optical assembly 44 may receive light 46 transmitted laterally through the optical fiber 12 (e.g., for optical fibers 12 illuminated by a back light source 24) and/or reflected off the outer surface 33 of optical fiber 12 (for optical fibers 12 illuminated by a front light source 24). The optical assembly 44 may transmit the received light 46 into the lens assembly 40, which then focuses the light 46 onto the image sensor 38 to form an image of one or more regions of the optical fiber 12 within a field of view of the imager 22. The image sensor 38 may be configured to capture color images (e.g., using a Bayer filter mosaic) or monochromatic images. In an embodiment of the imager 22, the image sensor 38 may be provided by a Manta G-223B C-mount camera, which can be obtained from Allied Vision of Taschenweg, Germany, and the lens assembly 40 may include a MML1.5-HR110 lens, which can be obtained from the Moritex Corporation of Kanagawa, Japan.

The optical assembly 44 may include one or more prisms, mirrors, and/or other optical elements that enable the image sensor 38 and lens assembly 40 to image portions of a fiber that would otherwise extend beyond the field of view provided by the image sensor 38 and lens assembly 40, e.g., by folding the image. The optical assembly 44 may thereby exploit the fact that the optical fiber 12 is long and narrow by projecting different portions of the optical fiber 12 onto different regions of the image sensor 38 that would otherwise only capture additional background area for the image.

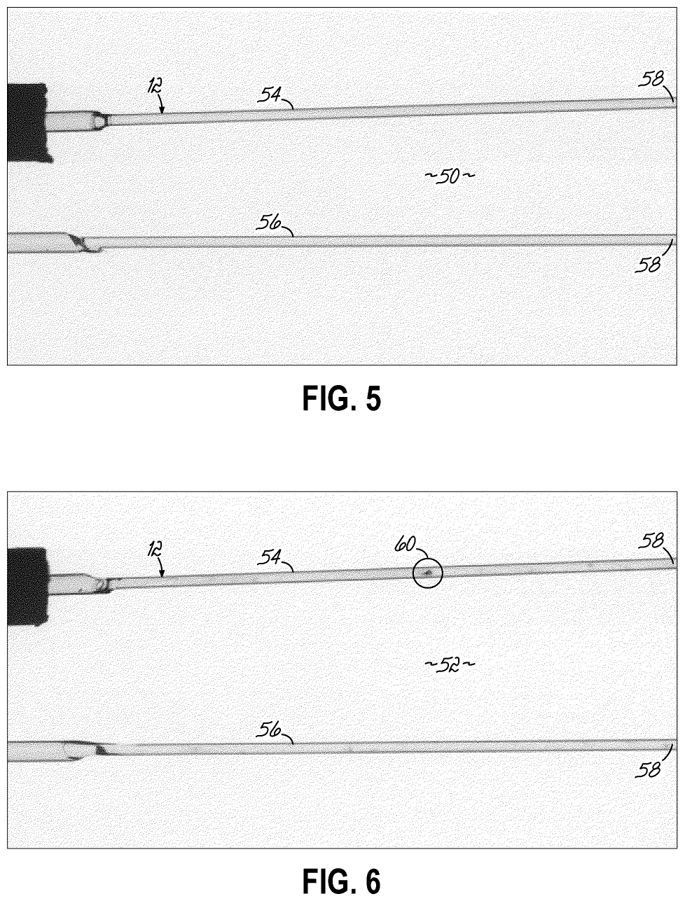

FIGS. 5 and 6 depict exemplary area images 50, 52 of optical fibers 12. Each image 50, 52 has been optically folded such that one portion 54 of each optical fiber 12 is shown above another portion 56 of the optical fiber 12. In this embodiment, the optical assembly 44 may be configured so that the end 58 of each portion 54, 56 of optical fiber 12 on the right side of each image 50, 52 is associated with a common point along the respective optical fiber 12. Accordingly, the bottom portion 56 of each optical fiber 12 may represent the portion of optical fiber 12 extending to the right beyond the top portion 54, but that is optically folded back to generate the image 50, 52. The image 52 illustrated by FIG. 6 also depicts exemplary debris 60, which is visible on the top portion 54 of optical fiber 12.

Optical image mapping may enable the optical assembly 44 to map a relatively large section of optical fiber 12 into a relatively small image sensor 38 in cases where the optical fiber 12 would otherwise be too long to fit within the field of view of the imager 22. Optical image mapping may enable improved resolution of the optical fiber 12 due to the imager 22 being able image lengths optical fiber 12 at a higher magnification than would be possible without optical image mapping. The optical assembly 44 may perform this mapping by dividing light received from the optical fiber 12 into portions (e.g., two horizontally separated halves), and then rearranging the portions so that they are provided to different regions of the image sensor 38 (e.g., two vertically separated halves of the image sensor 38).

The length of the optical fiber 12 that can be imaged may also be increased by the linear stage 26 moving the imager 22 in the x-direction 34 parallel to the optical fiber 12. This movement may allow the imager 22 to capture multiple images of the optical fiber 12 along the length thereof. For embodiments in which the imager 22 is a line imager, movement of the imager 22 relative to the optical fiber 12 may be used to image the length of optical fiber 12 by scanning the imager 22 along the length of the optical fiber 12.

In operation, the controller 32 may cause the imager 22 to capture images at predetermined angles. This may be accomplished by causing the rotary stages 28 to pause at each predetermined angle and triggering the imager 22 to capture an image, by causing the rotary stages 28 to rotate continuously and triggering the imager 22 to capture images at the predetermined angles, or by opening a shutter of the imager 22, strobing one or more light sources 24 at the predetermined angle(s), and then closing the shutter.

The rotary stages 28 may turn the optical fiber 12 while the imager 22 captures images of optical fiber 12. Rotation may be continuous, or the rotary stages 28 may stop at predetermined angles, e.g., in 30 degree increments, so that the imager 22 captures images at predetermined angles. The imager 22 may thereby image the entire outer surface 33 of optical fiber 12 (for front illumination) and/or capture a plurality of images indicative of the optical density of the optical fiber 12 (for back illumination). The controller 32 may synchronize image capture with movement of the rotary stages 28 so that an image is captured at each angle in which the optical fiber 12 is oriented. The rotary stages 28 may be mechanically geared or electronically controlled to have the same angle so that the optical fiber 12 is not twisted. A single image representing the entire outer surface 33 of optical fiber 12 and/or a three-dimensional model of the optical fiber 12 may then be constructed from the captured images. For example, tomographic reconstruction may be used to reconstruct the optical fiber 12 based on a plurality of back-lit images captured by the imager 22. Depending on length, the optical fiber 12 may be suspended from a single rotary stage 28 or held taught between multiple (e.g., two) rotary stages 28.

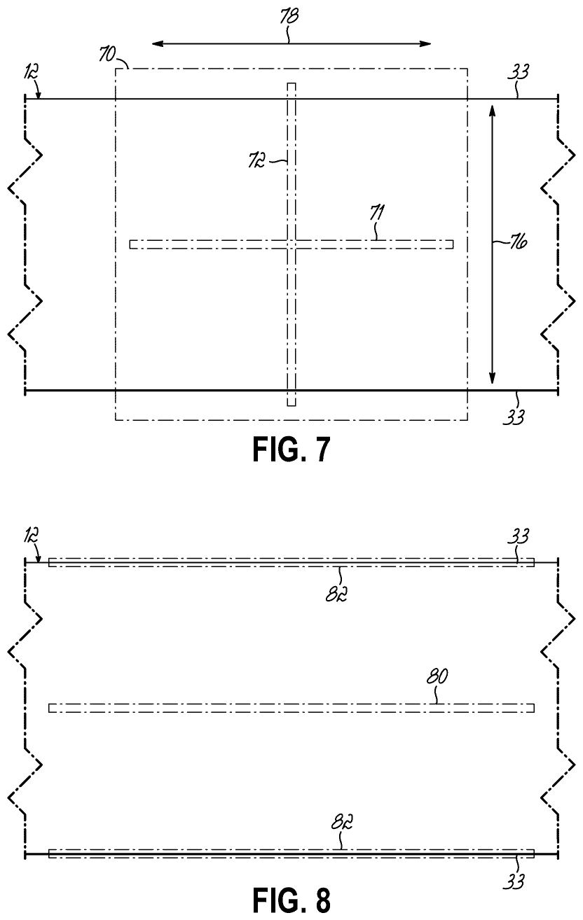

FIG. 7 depicts exemplary fields of view that may be used with various embodiments of the imager 22. The imager 22 may be an area scan imager having a field of view 70 encompassing an area, e.g., a square or rectangle. An area scan imager may be able to capture the entire optical fiber 12 using a relatively small number of images. In an alternative embodiment, the imager 22 may be a line scan imager having a field of view 71, 72 that is essentially one dimensional such that the imager's field of view may be referred to as a “line of view”. Image data captured by a line scan imager may have a narrow width, e.g., one pixel. Two-dimensional images may then be captured by moving the imager 22 along a scan line perpendicular to the line of view.

Scan line imagers may be oriented so that the line of view is either parallel to the optical fiber 12 (as depicted by field of view 71) or perpendicular to the optical fiber 12 (as depicted by field of view 72). For a scan line imager having a line of view parallel to the optical fiber 12, the imager 22 may be scanned across the optical fiber 12 laterally as depicted by double arrowed line 76. For a scan line imager having a line of view perpendicular to the optical fiber 12, the imager 22 may be scanned along the optical fiber 12 axially (i.e., lengthwise) as depicted by double arrowed line 78.

FIG. 8 depicts exemplary imaging regions including a central region 80 and edge regions 82. The central region 80 may be associated with a portion of the outer surface 33 of optical fiber 12 having a normal relationship to the line of sight of imager 22, i.e., that is generally parallel to and facing the imager 22. Edge regions 82 may be associated with portions of the outer surface 33 of optical fiber 12 having a tangential relationship to the line of sight of imager 22, i.e., that are generally orthogonal to the imager 22. The fiber inspection system 20 may capture images at each angle of a predetermined set of angles, and if required, at each position of a predetermined set of imager positions. The predetermined angles and positions may be configured to enable reconstruction of a 360 degree image of all relevant portions of the outer surface 33 of optical fiber 12.

The imager 22 may be adjusted (e.g., by adjusting the z-position of the imager 22 or the lens assembly 40) so that the central region 80 is focused on the outer surface 33 of optical fiber 12 facing the imager 22. A plurality of captured central regions 80 may then be used to build a surface map of the optical fiber 12 using front light intensity (reflection) and/or backlight intensity (transmission) differences. One or more of the edge regions 82 may be used to build a surface map showing protrusions above the outer surface 33 of optical fiber 12 using front light and/or back light intensities. The full area of the optical fiber 12 may be used for a full tomographic reconstruction to identify internal features/defects of the optical fiber 12.

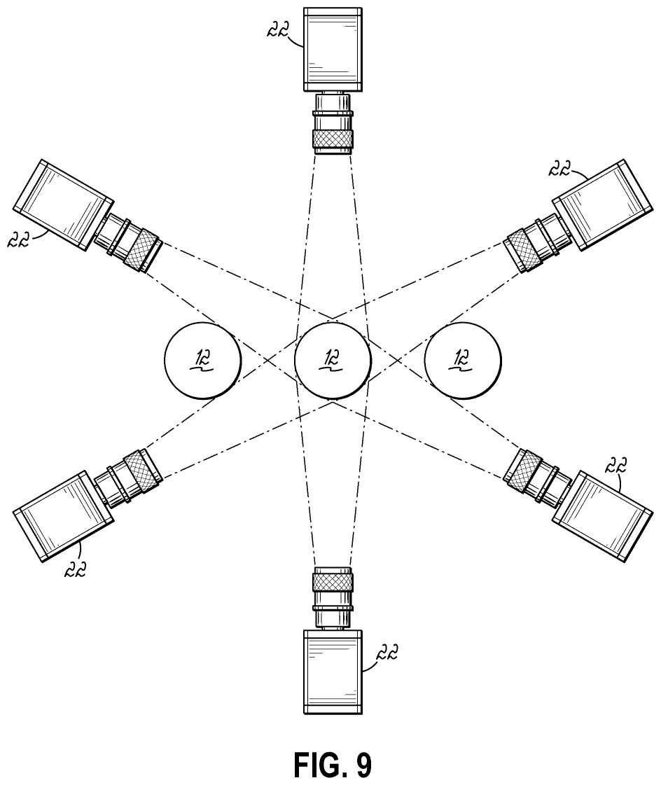

FIG. 9 depicts exemplary positioning of the imager 22 relative to an optical fiber 12 that is part of a fiber optic cable 10 including a plurality of optical fibers 12, e.g., a ribbon cable. As can be seen, the imager 22 may be unable to obtain images of the optical fiber 12 under test from certain angles due to the imager's line of sight being blocked by neighboring optical fibers 12. Accordingly, fiber optic cables 10 utilizing multifiber connectors, such as an optical cable having an OPTTIP MT connector (available from Corning Optical Communications LLC of Charlotte, North Carolina, United States), may impede certain techniques for imaging the entire outer surface 33 of optical fiber 12. A full surface image may still be obtained in these cases using partial images from the central region 80 and edge regions 82, by selecting predetermined angles that avoid angles where the neighboring optical fibers 12 block the line of sight of the imager 22, and/or by using tomography to extract surface features from backlight intensity images taken at the available angles. The rotary stages 28 may rotate the optical fiber 12 under test so that the imager 22 can see the optical fiber 12 at any angular position, such as at each of the angular steps noted above.

An exemplary method for inspecting optical fibers uses the imager 22 and at least one light source to image the surface of one or more optical fibers 12. Imaging may include rotating the optical fiber 12 or each optical fiber 12 relative to the imager 22 while the imager 22 captures plurality of images at different rotational angles. In an alternative embodiment, the optical fiber 12 may be held steady while the imager 22 is rotated around the optical fiber 12. In yet another alternative embodiment, the fiber inspection system 20 may include a plurality of imagers 22 placed circumferentially around the axis of rotation 30 so that the images can be captured from different rotational angles without the need to physically rotate either of the optical fiber 12 or imager 22. Multiple imagers 22 may also be used to reduce the amount of rotation necessary to image the optical fiber 12, e.g., by using two cameras spaced 180 degrees apart, and rotating the optical fiber 12 to each of six angular positions spaced 30 degrees apart to capture images over a full 360 degrees.

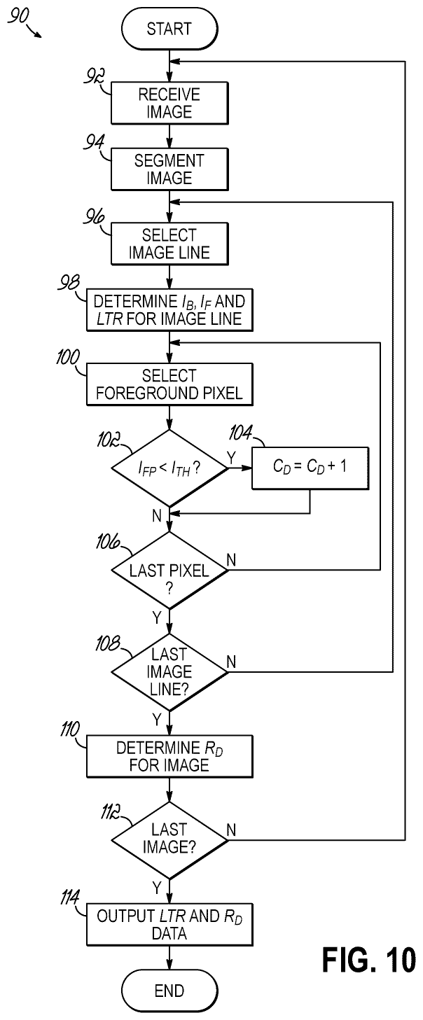

FIG. 10 depicts a flowchart illustrating an exemplary process 90 for analyzing one or more images of the optical fiber 12 to determine its level of cleanliness. The images may be analyzed individually, after they have been assembled into a composite image of the optical fiber 12, or in any other suitable manner. Based on this analysis, one or more “defect percentage” (R_{D}) and “light transmission ratio” (LTR) values may be output as indicators of fiber cleanliness. As used below, the term “pixel” refers to a fundamental unit of the image being analyzed. However, it should be understood that each pixel of the image being analyzed may include or otherwise be derived from one or more pixels (e.g., one, four, nine, or 16 pixels, etc.) of one or more images received from the imager 22. For example, one or more images received from the imager 22 may be stacked, scaled, or otherwise processed to produce an image for cleanliness analysis having a different number and/or size of pixels than the images received from the imager 22.

In block 92, the process 90 receives an image for processing, and proceeds to block 94. In block 94, the process 90 segments the received image along a dimension corresponding to the length of the optical fiber to generate a plurality of image lines. Each image line may have a predetermined width (e.g., one pixel) and a height sufficient to include the width of the optical fiber 12 as well as at least some of the background of the image. The process 90 may then proceed to block 96 and select an image line for analysis.

In block 98, the process 90 may determine a background intensity I_{B}, a foreground intensity I_{F}, and a light transmission ratio LTR for the received image line. To this end, the process 90 may classify each pixel in the received image line as either representing the optical fiber 12 (referred to as a foreground pixel P_{FG}) or as not representing the optical fiber 12 (referred to as a background pixel P_{BG}). This determination may be made based on the position of the pixel in the image line, an intensity or color of the pixel, or any other characteristic of the pixel suitable for classifying the pixel as either representing the optical fiber 12 or a background region of the received image. In cases where a pixel does not clearly belong to one of the background or foreground regions of the image (e.g., the pixel straddles a boundary between the optical fiber 12 and the background), the pixel may be ignored or discarded.

The process 90 may determine the background intensity I_{B} for the received image line by taking an average intensity of the background pixels of the image line. In a similar manner, the process 90 may determine the foreground intensity I_{F} for the received image line by taking an average intensity of the foreground pixels of the image line. The process 90 may then determine the light transmission ratio by determining the ratio of the foreground intensity I_{F} to background intensity I_{B} as follows:

$$L T R = \frac{{I}_{F}}{{I}_{B}} \qquad ( Eqn . 1 )$$

Advantageously, the light transmission ratio may eliminate effects arising from non-uniform illumination by the light source 24.

In block 100, the process 90 may select a foreground pixel P_{FG} from the plurality of foreground pixels of the selected image line. The process 90 may then proceed to block 102 and compare the intensity I_{FP} of the selected foreground pixel P_{FG} to a threshold intensity I_{TH}. The threshold intensity I_{TH} may be determined for the selected image line as a predetermined percentage of the background intensity I_{B} for that image line, e.g., I_{TH}=I_{B}×W, where W is a weighting factor equal to the percentage.

If the intensity I_{FP} of the selected foreground pixel P_{FG} is less than the threshold intensity I_{TH}, (“YES” branch of decision block 102), the pixel may be considered indicative of a defect. In this case, the process 90 may proceed to block 104 and log the defect by incrementing a defect counter CD, then proceed to block 106. If the selected foreground pixel intensity I_{FP} is not less than the threshold intensity I_{TH}, (“NO” branch of decision block 102), the process 90 may proceed to block 106 without logging a defect. Foreground pixels P_{FG} may identify or not identify a defect according to the following equation:

$$\begin{matrix}{P}_{F G} = defect identified & if {I}_{F P} < {I}_{T H}\end{matrix} \qquad ( Eqn . 2 )$$

$${P}_{F G} = defect not identified \qquad if {I}_{F P} \geq {I}_{T H}$$

In block 106, the process 90 may determine if the selected foreground pixel P_{FG} is the last of the foreground pixels in the image line. That is, the process 90 may determine whether all of the foreground pixels P_{FG} for the image line have been analyzed. If the foreground pixel P_{FG} is not the last pixel (“NO” branch of decision block 106), the process 90 may return to block 100, select another foreground pixel P_{FG}, and continue analyzing the selected image line. If the foreground pixel is the last pixel (“YES” branch of decision block 106), the process 90 may proceed to block 108 and determine if the selected image line is the last image line of the received image.

If the image line is not the last image line (“NO” branch of decision block 108), the process 90 may return to block 96, select the next image line, and continue analyzing the received image. If the image line is the last image line (“YES” branch of decision block 108), the process 90 may proceed to block 110 and determine the defect percentage R_{D} for the received image. The defect percentage R_{D} may be determined by dividing the number of defective foreground pixels by the total number of foreground pixels in the pixel lines as follows:

$${R}_{D} = \frac{\# defective {P}_{F G}}{\# total {P}_{F G}} \qquad ( Eqn . 3 )$$

In block 112, the process 90 may determine if the received image is the last image to be analyzed for the optical fiber 12 under test. If received image is not the last image to be analyzed (“NO” branch of decision block 112), the process 90 may return to block 92, receive another image to be analyzed, and begin analyzing the newly received image. If received image is the last image to be analyzed (“YES” branch of decision block 112), the process 90 may proceed to block 114 and output values for the light transmission ratio LTR and the defect percentage R_{D}. The values of the light transmission ratio LTR and the defect percentage R_{D} may be determined for the entire stripped area of the optical fiber 12, or the stripped area of the optical fiber 12 may be divided into a plurality of zones, and values of the light transmission ratio LTR and the defect percentage R_{D} determined for each zone. Zonal information may be useful, for example, to determine which part of the stripped area of the optical fiber 12 would have the greatest impact on performance.

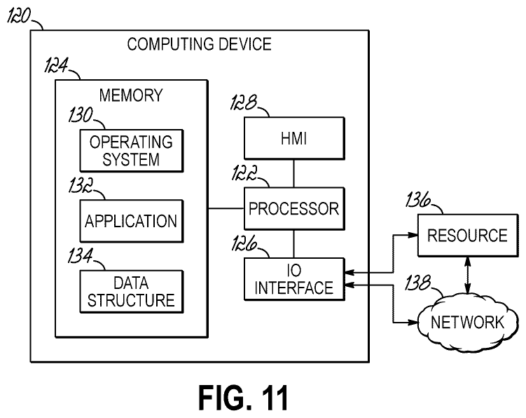

Referring now to FIG. 11, various features and attributes described herein (e.g., the system controller 32) may be implemented using one or more computer devices or systems, such as exemplary computer 120. The computer 120 may include a processor 122, a memory 124, an input/output (I/O) interface 126, and a Human Machine Interface (HMI) 128. The processor 122 may include one or more devices that manipulate signals or data based on operational instructions stored in memory 124. Memory 124 may include one or more devices configured to store information in the form of digital data.

The processor 122 may operate under the control of an operating system 130 that resides in memory 124. The operating system 130 may manage computer resources so that computer program code embodied as one or more computer software applications 132 residing in memory 124 can have instructions executed by the processor 122. One or more data structures 134 may also reside in memory 124, and may be used by the processor 122, operating system 130, or application 132 to store or manipulate data.

The I/O interface 126 may provide a machine interface that operatively couples the processor 122 to other devices and systems, such as the imager 22, light sources 24, linear stage 26, and/or rotary stages 28. The application 132 may thereby work cooperatively with the other devices and systems by communicating via the I/O interface 126 to provide any of the features described herein or their equivalents. The application 132 may also have program code that is executed by one or more external resources, or otherwise rely on functions or signals provided by other system or network components external to the system controller 32. Indeed, given the nearly endless hardware and software configurations possible, persons having ordinary skill in the art will understand that embodiments may include applications that are located externally to the computer 120, distributed among multiple computers or other external resources, or provided by computing resources (hardware and software) that are provided as a service over a network, such as a cloud computing service.

The HMI 128 may be operatively coupled to the processor 122 to allow a user to interact directly with the computer 120. The HMI 128 may include video or alphanumeric displays, a touch screen, a speaker, and any other suitable audio and visual indicators capable of providing data to the user. The HMI 128 may also include input devices and controls such as an alphanumeric keyboard, a pointing device, keypads, pushbuttons, control knobs, microphones, etc., capable of accepting commands or input from the user and transmitting the entered input to the processor 122.

The computer 120 may also be operatively coupled to one or more external resources 136, e.g., via a communication network 138. External resources may include, but are not limited to, servers, databases, mass storage devices, peripheral devices, cloud-based network services, or any other resource that may be used by the computer 120 to implement any of the features described herein or their equivalents.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative system and methods and illustrative examples shown and described. Accordingly, departures may be made from such details without departing from the scope of the present disclosure.

What is claimed is:

1. A system for connectorizing an optical fiber, comprising:
one or more processors; and
a memory including program code that, when executed by the one or more processors, causes the system to:
receive an image of the optical fiber;
segment the image along an image dimension corresponding to a length of the optical fiber to generate a plurality of image lines, each image line including a plurality of foreground pixels associated with the optical fiber and a plurality of background pixels associated with a background of the image;
for each image line:
define a background intensity based on one or more background pixels of the plurality of background pixels,
define a foreground intensity based on one or more foreground pixels of the plurality of foreground pixels,
compare the foreground intensity to the background intensity to identify any defects, and
log each defect identified;
pass the optical fiber if a number of defects logged is below a predetermined defect threshold; and
not pass the optical fiber if the number of defects is not below the predetermined defect threshold.

2. The system of claim 1, wherein the foreground intensity is an average of an intensity of each foreground pixel, the background intensity is an average of the intensity of each background pixel, and the program code causes the system to compare the foreground intensity to the background intensity by:
determining a light transmission ratio as a ratio of the foreground intensity of the image line and the background intensity of the image line;
comparing the light transmission ratio to a predetermined light transmission threshold; and
identifying a defect if the light transmission ratio differs from the predetermined light transmission threshold by more than a predetermined amount.

3. The system of claim 1, wherein the program code causes the system to compare the foreground intensity to the background intensity by, for each foreground pixel:
defining a threshold intensity as a percentage of the background intensity,
comparing the intensity of the foreground pixel to the threshold intensity,
identifying the defect if the intensity of the foreground pixel is less than the threshold intensity, and
not identifying the defect if the intensity of the foreground pixel is not less than the threshold intensity.

4. The system of claim 1, wherein the image received is one of a plurality of images of the optical fiber, and the number of defects logged represents a sum of the number of defects identified in each image of the plurality of images.

5. The system of claim 4, further comprising:
an imager in communication with the one or more processors,
wherein the program code further causes the system to capture at least one image of the optical fiber from each of a plurality of angular positions to generate the plurality of images of the optical fiber.

6. The system of claim 4, further comprising:
one or more rotary stages configured to rotate the optical fiber relative to the imager,
wherein the program code causes the system to capture the image of the optical fiber from each of the plurality of angular positions by rotating the optical fiber relative to the imager, and activating the imager each time the optical fiber is at one of the plurality of angular positions.

7. The system of claim 5, wherein the program code causes the system to rotate the optical fiber in predetermined angular steps to each of the plurality of angular positions.

8. The system of claim 5, wherein the imager includes an image sensor and an optical assembly, and the optical assembly is configured to receive light from the optical fiber, optically divide the light into a plurality of portions, and map each portion of the light to a different region of the image sensor.

9. The system of claim 1, further comprising:
an imager in communication with the one or more processors; and
a linear stage in communication with the one or more processors and configured to operatively couple the imager to the optical fiber,
wherein the program code further causes the system to:
activate the linear stage to move the imager relative the optical fiber so that the imager is scanned along the length of the optical fiber;
capture a plurality of image lines as the imager is scanned along the length of the optical fiber; and
define the image from the image lines.

10. A method for connectorizing an optical fiber, comprising:
receiving an image of the optical fiber;
segmenting the image along an image dimension corresponding to a length of the optical fiber to generate a plurality of image lines, each image line including a plurality of foreground pixels associated with the optical fiber and a plurality of background pixels associated with a background of the image;
for each image line:
defining a background intensity based on one or more background pixels of the plurality of background pixels,
defining a foreground intensity based on one or more foreground pixels of the plurality of foreground pixels,
comparing the foreground intensity to the background intensity to identify any defects, and
logging each defect identified;
passing the optical fiber if a number of defects logged is below a predetermined defect threshold; and
not passing the optical fiber if the number of defects is not below the predetermined defect threshold.

11. The method of claim 10, wherein the foreground intensity is an average of an intensity of each foreground pixel, the background intensity is an average of the intensity of each background pixel, and comparing the foreground intensity to the background intensity comprises:
determining a light transmission ratio as a ratio of the foreground intensity of the image line and the background intensity of the image line;
comparing the light transmission ratio to a predetermined light transmission threshold; and
identifying a defect if the light transmission ratio differs from the predetermined light transmission threshold by more than a predetermined amount.

12. The method of claim 10, wherein comparing the foreground intensity to the background intensity comprises, for each foreground pixel:
defining a threshold intensity as a percentage of the background intensity,
comparing an intensity of the foreground pixel to the threshold intensity,
identifying the defect if the intensity of the foreground pixel is less than the threshold intensity, and
not identifying the defect if the intensity of the foreground pixel is not less than the threshold intensity.

13. The method of claim 10, wherein the image received is one of a plurality of images of the optical fiber, and the number of defects logged represents a sum of the number of defects identified in each image of the plurality of images.

14. The method of claim 13, further comprising:
capturing at least one image of the optical fiber from each of a plurality of angular positions to generate the plurality of images of the optical fiber.

15. The method of claim 13, wherein capturing the image of the optical fiber from each of the plurality of angular positions includes rotating the optical fiber relative to an imager, and activating the imager each time the optical fiber is at one of the plurality of angular positions.

16. The method of claim 14, wherein the optical fiber is rotated in predetermined angular steps to each of the plurality of angular positions.

17. The method of claim 14, wherein capturing the image comprises:
receiving light from the optical fiber;
optically dividing the light into a plurality of portions; and
optically folding the image by mapping each portion of the light to a different region of an image sensor.

18. The method of claim 10, wherein capturing the image comprises:
moving one of an imager or the optical fiber so that the imager is scanned along the length of the optical fiber;
capturing a plurality of image lines as the imager is scanned along the length of the optical fiber; and
defining the image from the image lines.

19. The method of claim 18, wherein the imager is a line imager.

20. A computer program product for connectorizing an optical fiber, comprising:
a non-transitory computer-readable storage medium; and
program code stored on the non-transitory computer-readable storage medium that, when executed by one or more processors, causes the one or more processors to:
receive an image of the optical fiber;
segment the image along an image dimension corresponding to a length of the optical fiber to generate a plurality of image lines, each image line including a plurality of foreground pixels associated with the optical fiber and a plurality of background pixels associated with a background of the image;
for each image line:
define a background intensity based on one or more background pixels of the plurality of background pixels,
define a foreground intensity based on one or more foreground pixels of the plurality of foreground pixels,
compare the foreground intensity to the background intensity to identify any defects, and
log each defect identified;
pass the optical fiber if a number of defects logged is below a predetermined defect threshold; and
reject the optical fiber if the number of defects is not below the predetermined defect threshold.
